(19) United States
(12) Patent Application Publication
(10) Pub. No.: US 2009/0077577 A1
(43) Pub. Date: Mar. 19, 2009

(54) Method and Apparatus for Determining Bandwidth Savings Achieved By Transforming Selected Broadcast Channels to Switched Digital Video Channels in a Content Delivery System Without Transformation of the Selected Channels

(75) Inventors: Fred J. Allegrezza, Hatfield, PA (US); Ludwig C. Lewis, Jamison, PA (US); John A. Schlack, Quakertown, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/855,298

(22) Filed: Sep. 14, 2007

(51) Int. Cl. H04N 7/16

(52) U.S. Cl. 725/14

(57) ABSTRACT

A method is provided for acquiring channel viewership information in a content delivery system. The method begins by receiving a plurality of messages over an access network each indicating that a subscriber is switching to a specified broadcast channel. The information obtained from the messages is aggregated to generate channel viewership information identifying a number of subscribers tuned to each broadcast channel over a period of time. The channel viewership information is presented in a selected format.

### FIELD OF THE INVENTION

The present invention relates generally to content delivery systems that deliver broadcast channels and switched digital video (SDV) channels to subscribers.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize the session manager to manage SDV and other sessions. For each channel change, the subscriber will set up a broadcast session with the session manager, which will determine if the requested channel is already being sent to the corresponding service group that the subscriber belongs to. The subscriber will be assigned to join the existing SDV session if the requested channel is available at the service group or assigned to a new SDV session if the requested channel is not available at the service group. The session manager will negotiate with the edge devices to allocate resources required for the session. The edge device (e.g., a digital modulator such as a QAM modulator) needs to dynamically retrieve the MPEG single program transport stream that carries the requested SDV program (likely via IP multicast) and generate the MPEG multiple program transport stream. As part of the session setup response message, the video tuning parameters such as frequency and MPEG program number are sent back to the subscriber to access the requested SDV channel.

While switched digital video systems can save bandwidth, they also require the deployment of additional hardware, typically at a considerable expense. Specifically, SDV systems require as many as 50 to 100 times more edge devices than are required by a conventional broadcast system. The edge devices represent as much as three-quarters or more of the total cost installing the SDV system. Accordingly, there is a tradeoff that needs to be made between the amount of bandwidth that is to be saved and the cost of the additional equipment that needs to be deployed to implement an SDV system. Currently, SDV systems are installed without detailed information concerning subscriber viewing patterns that can be used to determine which channels should be broadcast and which should be switched. This can be a deterrent to the installation of new systems. Moreover, when SDV systems are installed they are sometimes deployed with excess SDV capacity to ensure that as many broadcast channels can be converted to SDV channels as are needed to save the desired amount of bandwidth. This can be unduly expensive since many more edge devices may be deployed than can be used in a cost-effective manner to save bandwidth.

### BRIEF DESCRIPTION OF THE DRAWINGS

FIG. 1 shows one example of a content delivery system.

FIG. 2 shows one example of the headend depicted in FIG. 1.

FIG. 3 shows the logical architecture of one particular example of a set top terminal.

FIG. 4 shows one example of the hardware employed in the set top terminal of FIG. 3.

FIG. 5 shows one example of a method by which an SDV manager or other suitable entity is used to generate and present channel viewership information that can be used to select certain broadcast channels for delivery in an SDV configuration.

### DETAILED DESCRIPTION

As detailed below, a method, apparatus and system are provided for acquiring subscriber viewing information that can be used to determine a priori how much edge device hardware needs to be deployed to achieve various levels of bandwidths savings. This information can be acquired by installing the SDV software on the subscriber devices (e.g., set top terminals) so that the system operator, via its SDV session manager, can receive information in the form of SDV channel change requests from the subscribers. Significantly, the edge device hardware needed to actually implement the SDV sessions, beyond that required to simply broadcast channels, need not be deployed in order to transmit and receive the channel change requests. Since the channel change requests are sent from the subscriber devices to the SDV session manager whenever a subscriber changes from one channel to another, the channel change requests include the information needed to determine which channels should be broadcast and which should be switched to achieve the various levels of bandwidths savings. In this way the system operator can determine in a relatively inexpensive manner which channels to broadcast and which to switch to achieve the greatest bandwidth savings and the amount of edge device hardware that will be needed to transform the selected broadcast channels to SDV channels.

Channel change requests are one type of message that is communicated between the session manager and the subscriber using an SDV Channel Change Message (CCM) protocol, which can be implemented as a proprietary protocol or as an open standard. After a channel change request is passed from the subscriber to the session manager, the session manager would normally respond by sending a message that includes the necessary tuning information to the subscriber. In the present case such additional messages need not be sent from the session manager to the subscriber terminal.

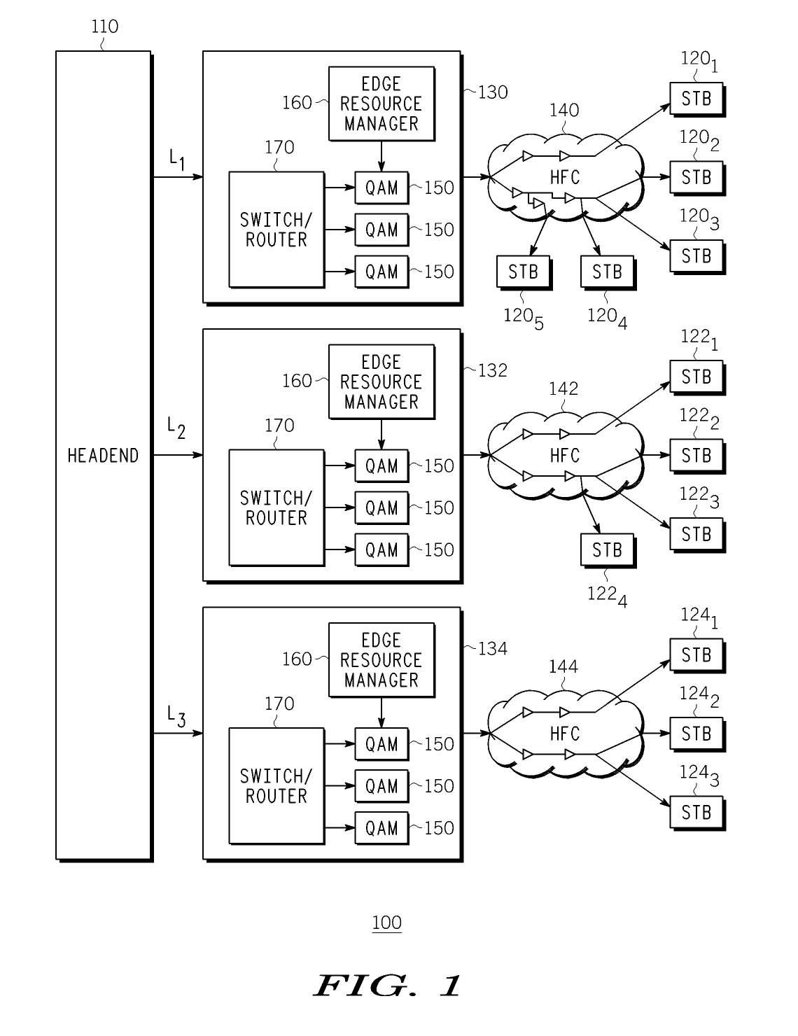

FIG. 1 is a content delivery system architecture 100 for delivering both broadcast channels and switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content distribution source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132, and 134 may communicate over a packet-switched network such as a cable data network, passive optical network (PON) or the like using, for example, IP multicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top or subscriber terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. For instance, as previously noted, the number of edge devices needed to implement SDV channels is generally much greater than the number of edge devices needed to implement broadcast channels. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110. In some case the edge resource manager and/or session manager can be located in the headend.

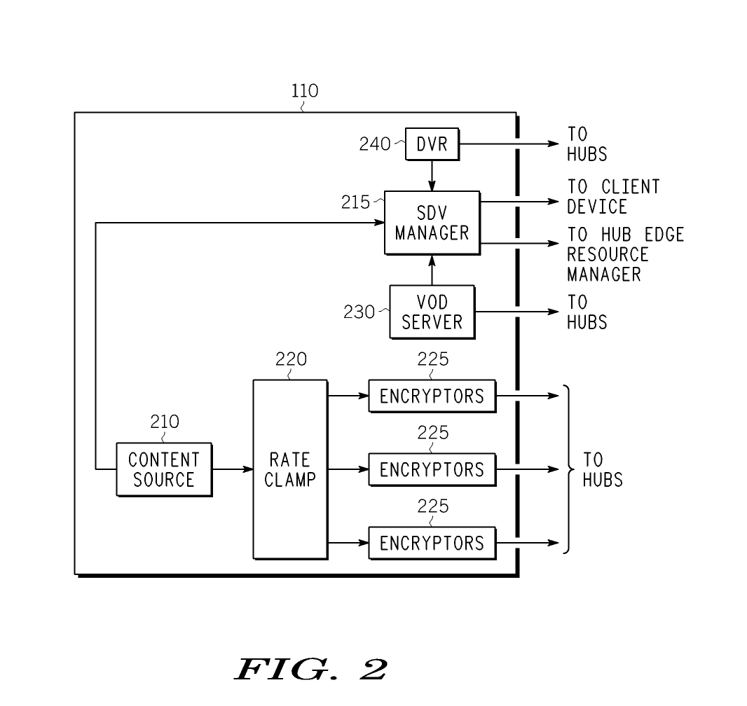

FIG. 2 shows one example of headend 110. The headend 110 includes a broadcast content source 210, which may include, by way of example, satellite receivers, off-air receivers and/or content storage devices such as servers. A SDV manager 215 is used to determine which SDV transport streams are being transmitted at any time and for directing the set top terminals to the appropriate stream. The SDV manager 215 also keeps track of which subscribers are watching which channels and it communicates with the edge resource managers 160 in the hubs so that the content can be switched on and off under the control of the SDV manager 215. In addition, all subscriber requests for a switched digital channel go through the SDV manager 215. The switched digital channels are forwarded to a rate clamp 220 and one or more encryptors 225 using, for example, IP multicast addressing. The content is then encrypted by the encryptors 225 and transmitted to the appropriate hub or hubs. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

Headend 110 may also include a network DVR 240. The network DVR 240 stores content that can be transmitted to set top terminal via a hub and access network in response to a user request to play a program stored on the DVR 240. Other user input requests are also serviced by network DVR 240, including, for example, requests to accelerate the playing of a program in the forward direction (e.g., cueing) and in the reverse direction (e.g., reviewing). The content is stored by the network DVR 240 upon a user request. The content may be provided to the network DVR 240 from any available content source, including, for example, content source 210.

It should be noted that in some cases the functionality of some or all of the SDV manager 215 may be transferred to each of the hubs 130,132 and 134. For example, as described below, Channel Change Messages may be communicated between the set top terminals and the hubs. In addition, some or all of the functionality of the SDV manager 215 may be distributed among other components such as an SDV operations manager (SDVOM), which is sometimes uses to configure and monitor SDV systems.

Headend 110 may also include a variety of other components for offering additional services. For example, in FIG. 2 a video on demand (VOD) server 230 is shown for storing programs or other content for distribution to subscribers on an on-demand basis. Although not shown, one of ordinary skill in the art would recognize that other components and arrangements for achieving the various functionalities of headend 110 are possible. For example, the head-end 110 may comprise typical head-end components and services including a billing module, an advertising insertion module, a subscriber management system (SMS), a conditional access system and a LAN(s) for placing the various components in data communication with one another. It will also be appreciated that the headend configuration depicted in FIG. 2 is a high-level, conceptual architecture and that each network may have multiple head-ends deployed using different architectures.

The edges devices 150 provide programming to the set top terminals using the downstream in-band channels. To communicate control information and the like with the headend 110 and/or the relevant hub, the set top terminals may use out-of-band (OOB) or DOCSIS channels or an IP tunnel or an IP connection and associated protocols. However, in some cases communication of control information and the like can be performed using in-band channels as well.

Control information that may be communicated over the out-of-band channels includes the aforementioned SDV Channel Change Messages (CCM), which are used to pass channel change requests from the subscriber to the SDV manager 215 in the headend 110. In particular, in a fully operational content delivery system that delivers SDV channels, the SDV manager 215 receives channel change requests for switched digital content from a set top terminal to bind that content to a session on one of the edge devices 150 serving that set top terminal's service group. The channel change request message is generated by the SDV application (or its designated proxy) resident in the set top terminal in response to the subscriber's program channel request that is entered through the set top terminal's user interface. The SDV manager 215 would normally respond to the set top terminal with the frequency and program number where that content may be found.

In the present situation the SDV Channel Change Messages are generated and transmitted by the set top terminal despite the fact that all the channels being delivered are broadcast channels and not SDV channels. A Channel Change Message, which as previously noted, may conform to an SDV Channel Change Message protocol, can be transmitted each and every time the subscriber tunes to a channel. Alternatively, the channel change information can be queued or accumulated in the set top terminal and sent at a later time after some predetermined number of channel changes have been performed or after a predetermined amount of time has elapsed or whenever there is sufficient bandwidth available. The SDV manager 215 receives the Channel Change Messages in order to gather statistics from which channel viewership information can be derived. The channel viewership information may be presented in any convenient form that shows the number of subscribers tuned to each channel over various periods of time, times of day, different days of the week, and the like. Convenient formats for presentation of the information include, for example, histograms and Pareto reports.

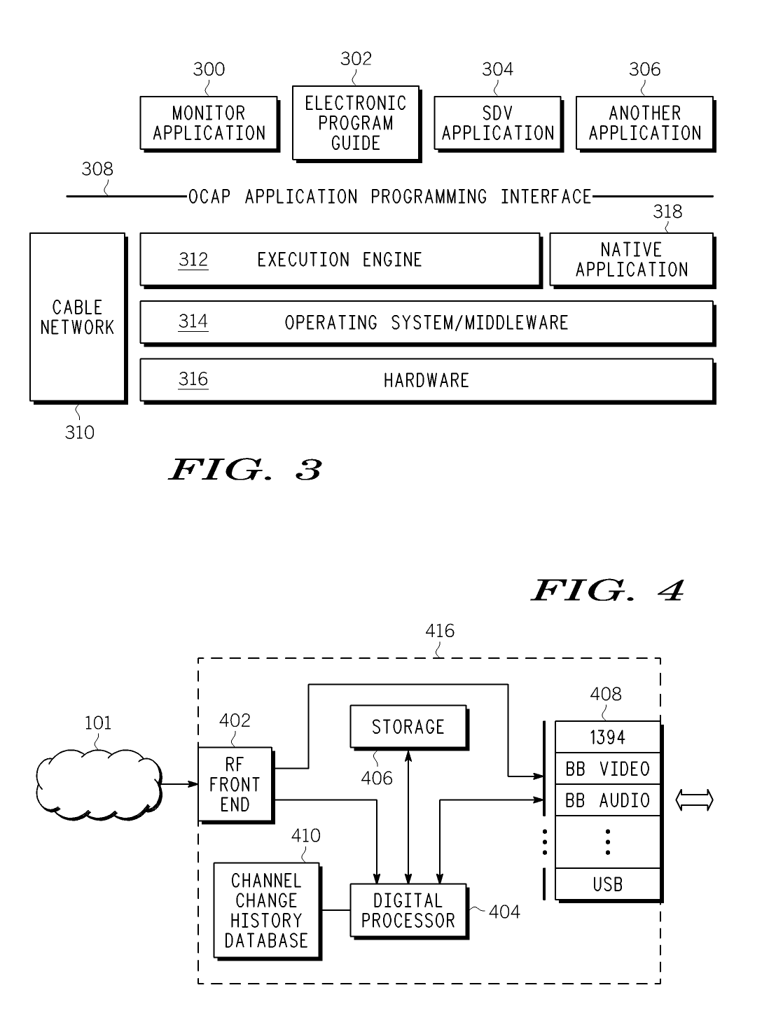

FIG. 3 shows the logical architecture of one particular example of a set top terminal. In this example the set-top terminal is compliant with the OpenCable Application Platform (OCAP) hardware and software environment. The OCAP specification is a middleware software layer specification intended to enable the developers of interactive television services and applications to design such products so that they will run successfully on any cable television system, independent of set-top or television receiver hardware or operating system software choices. As is well known, middleware generally comprises one or more layers of software which are positioned “between” application programs and the lower or physical layers of the network device. Middleware is commonly written for the specific requirements of the operator of the computer system, and the proprietary software purchased by the operator of the computer system. A key role of middleware is to insulate the application programs from the device specific details. By using middleware the application programmers need know very little about the actual network details, since they can rely on the middleware to address the complexities of interfacing with the network. Of course, the set top terminal is not limited to an OCAP-compliant software/hardware architecture. In other cases, for example, the client devices 106 may be compliant with MHEG, DASE or Multimedia Home Platform (MHP) middleware. Alternatively, the set top terminal may be based on a proprietary architecture.

Referring to FIG. 3, the top of an OCAP software “stack” includes a Monitor Application 300, Electronic Program Guide (EPG) 302, SDV application 304, and any other applications 306 that may be deployed in a particular network. These applications are run on top of a software layer called the “Execution Engine” 312 and interface to the Execution Engine using the well known OCAP APIs 308. The client device may also include certain software applications or “Native Applications” 318 that do not run within the Execution Engine, but directly run on top of the Operating System/Middleware 314 for the client device. Native Applications are typically written for, e.g., a particular hardware configuration 316 of the client device 106. Examples of such Native Applications may include management of front panel functionality, remote control interaction, games, and the like. The objects downloaded to the client device in accordance with the techniques described herein may include any of the aforementioned applications and programs as well as additional applications, programs or other objects. However, during an upgrade many of the objects that need to downloaded may be directed to applications located above the OCAP application programming interface 308.

When acquiring viewership information in accordance with the techniques described herein, the SDV application 304 is loaded onto the set top terminals. Once installed, the set top terminals can be readily configured to generate and transmit to the SDV manager the channel change requests, even if all the channels in the system are in a broadcast configuration.

FIG. 4 shows one example of the set top terminal hardware 416. The device hardware 416 generally includes an RF front end 402 (including a modulator/demodulator and a tuner or tuners) for interfacing with the distribution network (e.g., HFC network 140) of FIG. 1, digital processor(s) 404, storage device 406, and a plurality of interfaces 408 (e.g., video/audio interfaces, IEEE-1394 “Firewire”, USB, serial/parallel ports, etc.) for establishing communication with other end-user devices such as televisions, personal electronics, computers, WiFi or other network hubs/routers, etc. Other components which may be utilized within the device include one or more decoder stages, various processing layers (e.g., DOCSIS MAC, OOB channels, MPEG, etc.) as well as media processors and other specialized SoC or ASIC devices. These additional components and functionality are well known to those of ordinary skill in the art and accordingly are not described further herein.

As noted, the SDV application 304 is responsible for communicating the channel change information (e.g., SDV CCMs) between the set top terminal and the SDV manager. For this purpose the set top terminal hardware 416 may include a channel change history database 410 in which the accumulated channel change information can be stored until it is ready to be transmitted to the SDV manager.

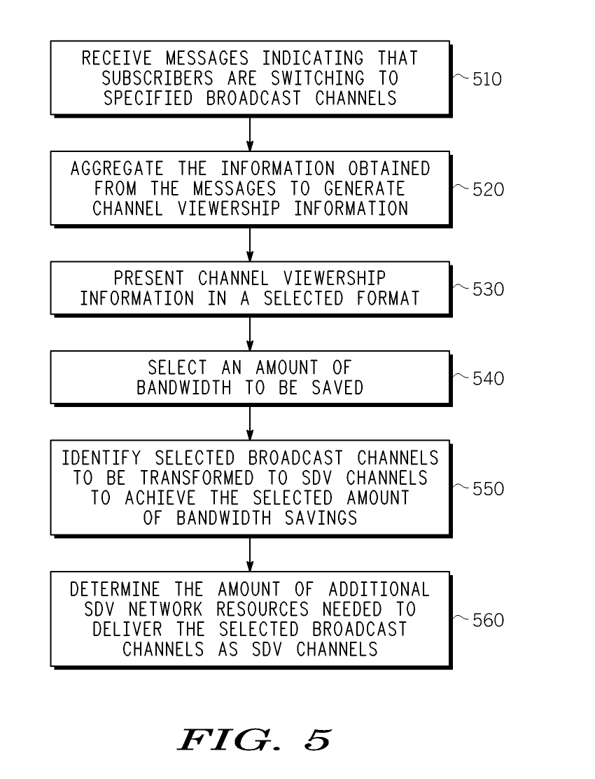

FIG. 5 shows one example of a method by which an SDV manager or other suitable entity (e.g., an SDVOM) is used to generate and present channel viewership information that can be used to select certain broadcast channels for delivery in an SDV configuration. The method begins in step 510 when the SDV manager or other entity receives a plurality of messages over a broadband access network each indicating that a subscriber is switching to a specified broadcast channel. In step 520 the information obtained from the messages is aggregated to generate channel viewership information identifying a number of subscribers tuned to each broadcast channel over a period of time. The channel viewership information is presented in a selected format in step 530. An amount of bandwidth to be saved is selected in step 540. Based on the channel viewership information and the amount of bandwidth to be saved, selected broadcast channels that need to be transformed to SDV channels to achieve the selected amount of bandwidth to be saved are identified in step 550. Finally, in step 560, the amount of additional SDV network resources needed to deliver the number of broadcast channels as SDV channels is determined.

As previously mentioned, some or all of the functionality of the SDV manager may be distributed among other components such as an SDV operations manager (SDVOM). For instance, while the SDV manager may acquire the individual subscriber information as in step 510 above, the SDVOM may aggregate the information and present the resulting channel viewership information as in steps 520 and 520.

The processes described above, including but not limited to those presented in connection with FIG. 5, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

A method and apparatus has been described for acquiring channel viewership information that can be used to select certain broadcast channels for delivery in an SDV configuration. In this way system operators can determine in a relatively inexpensive manner which channels to broadcast and which to switch to achieve the greatest bandwidth savings without actually deploying all the hardware necessary to implement a fully operational SDV system

1. A method of acquiring channel viewership information in a content delivery system, comprising:
receiving a plurality of messages over an access network each indicating that a subscriber is switching to a specified broadcast channel;
aggregating information obtained from the messages to generate channel viewership information identifying a number of subscribers tuned to each broadcast channel over a period of time; and
presenting the channel viewership information in a selected format.

2. The method of claim 1 wherein, based on the channel viewership information generated for the broadcast channels, further comprising selecting at least one of the broadcast channels for subsequent delivery over the access network as a switched digital video channel.

3. The method of claim 1 wherein the messages are received by a switched digital video manager associated with the content delivery system.

4. The method of claim 1 wherein the messages are received on one or more out-of-band channels.

5. The method of claim 2 wherein the selected broadcast channel is a channel having a smaller subscriber viewership than remaining ones of the broadcast channels.

6. The method of claim 2 wherein a plurality of the broadcast channels are selected for subsequent delivery as switched digital video channels by analysis of the channel viewership information to balance a savings in bandwidth achieved by transforming a broadcast channel into a switched digital video channel against an increased cost in deployment of additional switched digital video network resources.

7. The method of claim 2 further comprising selecting an amount of bandwidth to be saved and analyzing the channel viewership information to identify selected broadcast channels that need to be transformed to switched digital video channels to achieve the selected amount of bandwidth to be saved.

8. The method of claim 7 further comprising determining an amount of additional switched digital video network resources needed to deliver the selected broadcast channels as switched digital video channels.

9. The method of claim 8 wherein the additional network resources comprise additional edge devices delivering switched digital video programming.

10. The method of claim 9 wherein the edge devices comprise QAM modulators.

11. At least one computer-readable medium encoded with instructions which, when executed by a processor, performs the method set forth in claim 1.

12. At least one computer-readable medium encoded with instructions which, when executed by a processor, performs a method comprising:
receiving a user-request to tune to a first broadcast channel;
tuning to the first broadcast channel in response to the user-request;
generating information indicating a change in tuning status to the first broadcast channel; and
transmitting the information over a access network so that channel usage information can be determined.

13. The computer-readable medium of claim 12 wherein the information is transmitted in a Channel Change Message that conforms to a switched digital video Channel Change Message protocol.

14. The computer-readable medium of claim 13 further comprising:
locally storing the information associated with the user request to tune to the first broadcast channel;
transmitting the information over the access network in a single Channel Change Message after a prescribed number of user channel change requests have been received, said Channel Change Message including information associated with each of the prescribed user channel change requests.

15. The computer-readable medium of claim 12 wherein the information is transmitted to a switched digital video manager associated with a content delivery system.

16. The computer-readable medium of claim 12 wherein the information is transmitted on one or more out-of-band channels.

17. A set top terminal, comprising:
an RF front-end for receiving programming content over an access network;
a processor operatively associated with the RF front-end;
a storage medium operatively associated with the processor;
a user interface; and
wherein, responsive to channel change requests received via the user interface, the processor is configured to tune to various broadcast channels and generate a message indicating a change in tuning status to the first broadcast channel.

18. The set-top terminal of claim 17 wherein the processor is further configured to cause the message to be transmitted by the RF-front-end over the access network.

19. The set top terminal of claim 14 wherein the RF front-end is configured to transmit the message over the access network on an out-of-band channel.

20. The set top terminal of claim 18 wherein the message is transmitted to a switched digital video manager associated with a content delivery system.
